(19) United States
(12) Patent Application Publication
(10) Pub. No.: US 2014/0054235 A1
(43) Pub. Date: Feb. 27, 2014

(54) METHOD AND DEVICE FOR CLEANING WASTEWATER

(71) Applicant: Karl Bleicher, Landshut (DE)

(72) Inventor: Karl Bleicher, Landshut (DE)

(73) Assignee: AKW A+V PROTEC INDUSTRY GMBH, Hirschau (DE)

(21) Appl. No.: 14/110,474

(22) PCT Filed: Apr. 16, 2012
(86) PCT No.: PCT/EP2012/056906

§ 371 Date: Nov. 11, 2013

(30) Foreign Application Priority Data
Apr. 19, 2011 (DE) 10 2011 018 190.3

(51) Int. Cl. C02F 1/66

(52) U.S. Cl. CPC C02F 1/66
USPC 210/743; 210/96.1

(57) ABSTRACT

The invention relates to a method and to a device for cleaning wastewater, in particular organically polluted wastewater, by means of adding a nitrate source, the method comprising the following steps: filling the wastewater in a container until a first fill level (Niv A) of the reactor is reached, wherein the fill level (Niv A) is 80-99%, preferably 95%, mixing the waste water, measuring the pH value of the wastewater, wherein lye is added to the wastewater if the wastewater has a pH value of <7.0 until a pH value of 7.5 is reached, adding nitrate to the wastewater, stirring the wastewater-nitrate mixture, controlling the addition of further nitrate and/or further lye by measuring at least one parameter of the wastewater-nitrate mixture, ending the stirring motion, and decanting with clarified water discharge at a second fill level (Niv B), wherein the fill level (Niv B) is 50-70%, preferably 60%.

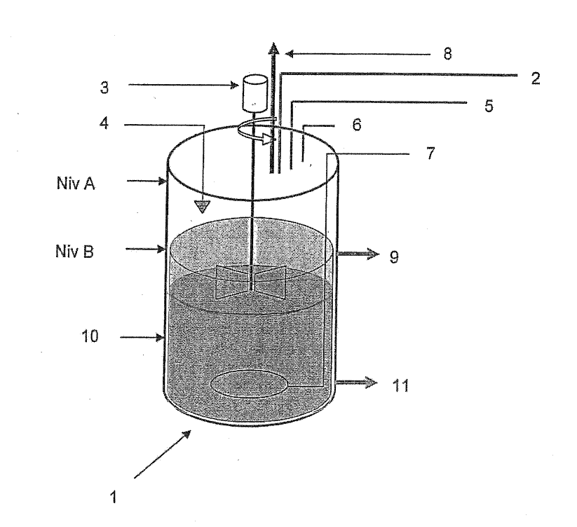

The invention relates to a method for the purification of waste waters, in particular of organically contaminated waste waters, by the addition of a nitrate source, according to the combination of features of patent claim 1, and to a device for carrying out a method for the purification of waste waters, according to the combination of features of patent claim 13.

In conventional waste water engineering oxygen is used as terminal electron acceptor for the oxidation of organic materials in the waste waters. To purify the waste water, the oxygen is rendered soluble, finely distributed, and dosed according to need.

It is known to use enriched gas or pure oxygen for the purification of waste waters. The aim of such efforts is to increase the dissolved oxygen content, and thus the availability of the terminal electron acceptor.

A great drawback of this technology is, on the one hand, the limited oxygen content in the air and, on the other hand, the limited solubility of oxygen in water (approximately 8 mg/l at 20° C.). In addition, parameters like the salt content, pressure and especially temperature have a considerable influence on the availability of dissolved oxygen for the purification of waste water.

Based on the foregoing, it is an object of the present invention to provide a further developed method for the purification of waste waters, waiving the use of oxygen or pure oxygen. Furthermore, a device is provided, by means of which such a method can be carried out.

The solution to the object of the invention is achieved by a method for the purification of waste waters, in particular of organically contaminated waste waters, according to the teaching of patent claim 1, and by a device for carrying out a method for the purification of waste waters by the addition of nitrate, according to the teaching of patent claim 13. The dependent claims represent at least advantageous embodiments and further developments.

The inventive method for the purification of waste waters is specifically suited for the purification of organically contaminated waste waters, and is based on the addition of a nitrate source to the waste water to be purified. With respect to the purification, basically the following steps are performed:

Initially, each purifying cycle commences with filling a container with waste water. A preceding purifying cycle may have already been performed in the container before, so that a residue of waste water or sediment, respectively, and active biomass is contained in the container. The container is filled until a first filling level is reached. The filling level is at 80-99%, preferably at 95%.

Initially, the waste water contained in the container is mixed. In other words, the sediment or sludge contained in the container is mixed with the newly added waste water. Preferably, the mixing is carried out by a stirrer. The mixing process should be carried out for at least five minutes, so that a sufficient mixing of the sludge with the waste water can be guaranteed.

Subsequently, the pH-value of the waste water is measured. If the pH-value is less than 7.0, lye is added to the waste water until a pH-value of 7.5 is reached. Preferably, milk of lime is added.

Next, nitrate is added, or added in a quantitatively controlled manner, to the waste water. The nitrate may be added, for example, in the form of nitric acid, preferably 25-50% nitric acid or dissolved nitrate salt, e.g. Ca, Na-nitrate. Preferably, the nitric acid, after it has been added to the waste water, has a molar concentration (c) of 100 mg/l or a pH-value of 6.5.

Subsequently, the waste water/nitrate mixture is stirred. The stirring process may be carried out at intervals, so that the stirrer is operated, for example, for 30 seconds, followed by a pause of 150 seconds. This operation/pause sequence may be repeated for several hours. The stirring avoids, on the one hand, the formation of floating layers and, on the other hand, prevents supersaturations of gases.

In addition, the purification method according to the invention provides for a controlled addition of an additional nitrate source and/or additional lye, the control being performed in response to the measurement of at least one parameter of the waste water/nitrate mixture.

Preferably, the measurement of the pH-value of the waste water/nitrate mixture is performed if waste waters are contaminated to a relatively small extent. If the pH-value is greater than 7.0 additional nitrate is added to the waste water/nitrate mixture. It may be mentioned that, again, a nitric acid solution may be used. No more nitrate or nitric acid solution is added as soon as the waste water/nitrate mixture has a pH-value of 7.0 or less.

If the waste water/nitrate mixture contains a contamination and active biomass, an alkalization to the original pH-value takes place within a short period. Basically, nitrate is added to the waste water/nitrate mixture until the alkalization occurs no longer. The non-occurrence denotes the termination of the biological purification of the waste water.

Furthermore, it is conceivable that the addition of additional nitrate and/or additional lye takes place on the basis of the measurement of the nitrate concentration in the waste water/nitrate mixture. Depending on the contamination of the waste water it is provided to operate the purifying device in a specific nitrate range, e.g. at 50-200 mg/l. The nitrate concentration is here determined by means of a probe and continuously monitored during the period of the purification process, so as to allow the detection of fluctuations and variations of the concentration. The controlled addition of additional nitrate is then carried out in dependence on the concentration. The degree of contamination or organic contamination can be determined by the nitrate consumption.

If the concentration of organic components in the waste water is high, the acidification process is ready to start. This means that polymers present in the waste water are converted to organic acids. In such a case, it is impossible to use merely the pH-value for controlling the purification or for controlling the addition of additional nitrate and/or additional lye, respectively. It is necessary to measure the oxidation-reduction potential of the waste water/nitrate mixture in order to allow the controlling of the purification by the addition of additional nitrate and/or additional lye.

As soon as an acidification of the waste water/nitrate mixture is detected, i.e. the negative oxidation-reduction potential has a decreasing tendency, additional lye is to be added. The addition has to take place until the original pH-value is reached, i.e. 7.5.

An oxidation-reduction potential of <0 mV indicates commencing anaerobic processes and acidification. dpH/dt<0, i.e. a decreasing pH-value, too, is an indication that an acidification takes place. Preferably, both the pH-value and the oxidation-reduction potential are monitored.

As soon as the pH-value reaches again its original value a quantitatively controlled addition of nitrate may take place again, activating the denitrification, at which preferably the organic acids are dissipated so that, consequently, the acidification is counteracted.

If waste waters are organically contaminated to a great extent the waste water/nitrate mixture is, preferably, aerated with strip-air at intervals, the aeration taking place within five to ten minutes for a few seconds, e.g. approximately five seconds. The stripping of gases is accomplished for the purpose of preventing carbonation. In cases of highly contaminated waste waters it may occur that soluble gases, in particular CO₂ as degradation end product in the reaction suspension, or N₂, are built up and that the pH-value is very strongly buffered by carbonate. Dissolved gases are expelled at intervals by the air blasts emanating from the stripping device.

It was already described above that the non-occurrence of the alkalization of the waste water/nitrate mixture denotes the termination of the biological purification of the waste water, so that the stirring is stopped at this point in time. If dpH/dt=0, i.e. if the pH-value no longer changes and the oxidation-reduction potential>0 mV, the stirring process, which may take up to six hours, is stopped.

In order to avoid the above-described carbonation, the purifying process is preferably carried out in the pH-range of 6.5-7.0.

Next, the settlement of the activated sludge is initiated. After approximately 30 minutes the part of the mechanical waste water purification is concluded. The decantation takes place next, discharging the clarified water through an opening at a second filling level of the container. This second filling level is at 50-70%, preferably 60%. It can be seen that two operating levels or filling levels, respectively, are defined in the aforementioned container by means of level switches, which levels are preferably at 95% and 60%.

The decantation may last approximately 14 minutes. Once the clarified water is discharged a new purifying cycle may be carried out according to the method steps of the invention. After every fifth to tenth purifying cycle the excess sludge has to be drawn off.

The present method is particularly suited for the purification of waste waters containing easily degradable substances, because the oxidation power of the terminal electron acceptor is reduced in comparison with conventional oxygen. The denitrification may be assigned a standard Nernst potential of +400 mV, while the oxygen-based respiration is assigned a standard Nernst potential of +800 mV. However, to a limited extent the oxidation power of the reaction is sufficient for a plurality of organic substances having similar properties, such as alcohols, aldehydes, organic acids and already activated hydrocarbons, without substitution by hetero atoms such as nitrogen, sulphur and halogens.

Preferable fields of application are, therefore, waste waters whose chemical oxygen demand (COD) approximately corresponds to the biological oxygen demand (BOD). This applies, for example, to sugar- and starch-containing waste waters, to acids and alcohols.

The method according to the invention may be employed in a very wide field of application. The COD of the waste water may have a value of 200 mg/l to 20,000 mg/l.

Waste waters from the solar industry, which are contaminated with PEG as polymer, can likewise be purified with the method according to the invention. Hot waste waters can be purified particularly well by means of the method, because the activity of the microorganisms increases with the temperature. Waste water temperatures of up to 45° C. do not represent obstructions, as is the case with conventional purification methods. In other words, the standardized cooling of waste waters is not necessary. In the oxygen-based purification the negative solubility dependence at an increasing temperature represents a considerable limiting factor.

The denitrification or nitrate-based respiration, respectively, may be represented in a simplified manner:

3 HNO₃+15 [H]<−>1,5 N₂+9 H₂O

2 HNO₃+CH₃OH<−>N₂+CO₂3 H₂O

The following characteristics speak for the application of the method according to the invention:

Possible volume loads: up to 2-4 kg/m³*day COD degradation performance

Consumption of nitric acid: approx. 0.8-1.2 kg/kg COD degraded

Sludge accumulation: approx. 0.25 kg/kg COD degraded

The present invention additionally relates to a device which is configured to carry out the method according to the invention.

The device comprises a container with a settling cavity in the container bottom, as well as a stirrer and a pH-value measuring device, and a dosing device for the addition of a nitrate source. The container is dimensioned in accordance with the waste water quantity to be expected and the composition thereof, whereby exceeding a volume load of 4 kg COD/m³*day should be avoided. The container may have an optional geometry. Preferably, a container having a cylindrical geometry should be provided so as to render the mixing and stirring by means of the stirrer more easily.

Preferably, the device includes a nitrate concentration measuring device and/or an oxidation-reduction potential measuring device.

An aeration device or stripping device, respectively, may be provided as well. Such an aeration device is particularly advantageous if waste waters are organically contaminated to a great extent.

The container of the device comprises two operating levels or filling levels, respectively, which are preferably at 95% and 60%. The mentioned levels are defined by means of level switches, and an outlet for the discharge of clarified water is provided at the 60% filling level.

Other internal attachments such as one or more membrane ventilators in the form of plates or hoses, waste water inlet and outlet as well as a sludge discharging device are provided as well. Depending on the composition of the waste water a lye dosing device may be necessary.

The device for the purification of waste waters also comprises a temperature detecting device, if extreme temperature variations in the waste water are to be expected. If the waste water is contaminated to a great extent the degradation may come along with a measurable specific heat, which should likewise be included in the controlling, whereby a temperature variation in the waste water inlet of +/−5° C. around the previously defined operating point is allowable. At long time intervals the operating point can vary, for example, by 5° C. per week in a range between 15° C. and 45° C. This requires longer time periods for the adaptation of the biomass, however.

The inventive method for the purification of waste waters by the addition of nitrate, and the inventive device for carrying out a method for the purification of waste waters by the addition of nitrate shall be explained in more detail below, by means of embodiment examples and with reference to a figure.

### APPLICATION EXAMPLE 1

In the exemplary application of the inventive method described below waste water from the solar industry is purified. The cutting of silicon ingots comes along with a contamination of the waste waters with polyethylene glycol (PEG).

Quantity of waste water: 150 m³/day

COD (chemical oxygen demand) in the inlet: 2.500 mg/liter

Organic ingredients: PEG 200

The requirements for purified waste water are as follows:

COD: <500 mg/liter

Suspended matter: <400 mg/liter

For the application of the method according to the invention the following characteristics are decisive and typical:

COD degradation per day: 315 kg

Reactor volume: 150 m³ (distributed to 3 stirrer tanks having a volume of 50 m³)

Operating temperature: 28-32° C.

Volume load: 2.5 kg COD/m³*day

Consumption of nitric acid: 504 kg (50% solution) 3.4 cycles per day with a reaction time of 20 hours

### APPLICATION EXAMPLE 2

The following example demonstrates that the method according to the invention is also suited for the purification of waste waters in the food industry. The washing of grain contaminates waste waters organically to a moderate extent. However, a direct introduction thereof into a recipient is impossible.

Quantity of waste water: 100 m³/day

COD in the inlet: 250 mg/liter

Organic ingredients: starch

The requirements for the purified waste water are as follows:

COD: <100 mg/liter

For the application of the method according to the invention the following characteristics are decisive and typical:

COD degradation per day: 15 kg

Reactor volume: 50 m³

Operating temperature: 15-20° C.

Volume load: 0.5 kg COD/m³*day

Consumption of nitric acid: 57.6 kg (25% solution) 5 cycles per day with a reaction time of 15 hours

The figure illustrates a device for carrying out the inventive method for the purification of waste waters.

Firstly, waste water, which preferably is organically contaminated waste water, is supplied through an inlet 2 into container 1 of the device. The container 1 is filled up to a first filling level (Niv A). It may be the case that residual sludge from a preceding purification cycle is still present in the container. The first filling level (Niv A) is preferably at 95%, that is, 95% of the container 1 are filled.

Subsequently, the waste water is mixed. The mixing is accomplished by a stirrer 3, so that the residual components of a preceding purification cycle and the new waste water are mixed thoroughly. The mixing process lasts approximately 5 minutes, followed by a measurement of the pH-value. To this end, the device comprises measuring devices 4 which, in this case, is a pH-value sensor.

If a pH-value of less than 7.0 is detected, lye is added to the waste water, preferably in the form of milk of lime. This addition is accomplished by a lye dosing device 6 until a pH-value of 7.5 is reached.

In order to start the biological purification process nitrate is added to the waste water in container 1 by means of a nitrate dosing device 5. The nitrate induces a denitrification in container 1, so that the organic components of the waste water are bound and filtered out. Preferably, nitrate is added in the form of nitric acid, which has a molar concentration c=100 mg/l or a pH-value of 6.5.

In a stirring process the nitrate and the waste water are mixed thoroughly at intervals to obtain a waste water/nitrate mixture. Preferably, the device according to the invention comprises an aeration device 7. The aeration with strip-air is likewise performed at intervals. An aeration is particularly advantageous if the waste waters are organically contaminated to a great extent. The aeration takes place, for example, in a 5-minute purification phase for approximately 5 seconds. As a result of the aeration, for example, CO₂ or N₂ are expelled through the deaerator 8.

The present measuring devices carry out a measurement of the pH-value of the waste water/nitrate mixture. If the pH-value is greater than 7.0 nitric acid is added.

Furthermore, a measurement of the oxidation-reduction potential of the waste water/nitrate mixture is provided, whereby, with an arrangement of measuring devices 4, an oxidation-reduction potential measurement device is provided. If the pH-value decreases, and if the oxidation-reduction potential is less than 0 mV, a commencing anaerobic process and an acidification are noticed. This is suppressed by adding additional milk of lime to the waste water/nitrate mixture by means of the lye dosing device 6, until a pH-value of 7.5 is reached. As soon as this initial pH-value is reached, the biological purification can be continued by adding, by means of the nitrate dosing device 5, nitrate in the form of a nitric acid solution. With respect to the molar concentration and the pH-value the same parameters as those of the initial nitrate addition are chosen in this case. In connection with waste waters that are contaminated to a small extent this example demonstrates that the method according to the invention already allows the realization of the purification goal with a one-time nitrate dosage of 100 mg/l.

As soon as the pH-value no longer varies and the oxidation-reduction potential is greater than 0 mV, it can be assumed that the biological purification of the waste water is concluded. In this case, the stirrer 3 is stopped, followed by a settling phase, which is part of the mechanical purification of the waste water. Within approximately 30 minutes, sludge settles in a settling cavity in the bottom of the container.

Subsequently, the decantation process takes place, including the discharge of the clarified water. To this end, a clarified water outlet 9, through which the clarified water clarified by the settling process can be discharged, is positioned at the level of a second filling level (Niv B), which is preferably at 60%. Thus, there is an exchange ratio of approximately 30% of the reactor volume. After a 14-minute clarified-water discharge phase a sludge bed 10 remains in the container 1.

The purification cycle is concluded after the discharge of the clarified water, so that a new purification cycle can be started by filling the container 1 with “fresh” waste water. After approximately every fifth to tenth purification cycle the excess sludge has to be pumped off through a sludge outlet 11.

### LIST OF REFERENCE NUMBERS

1 container

2 inlet

3 stirrer

4 measuring devices

5 nitrate dosing device

6 lye dosing device

7 aeration device

8 deaerator

9 clarified water outlet

10 sludge bed

11 sludge outlet

Niv A first filling level

Niv B second pilling level

1. Method for the purification of waste waters, in particular of organically contaminated waste waters, by the addition of a nitrate source, characterized by the following steps:
a) filling the waste water into a container until a first filling level (Niv A) of the reactor is reached, the filling level (Niv A) being at 80-99%, preferably at 95%,
b) mixing the waste water,
c) measuring the pH-value of the waste water, wherein, if the pH-value of the waste water is <7.0, lye is added to the waste water until a pH-value of 7.5 is reached,
d) adding nitrate to the waste water,
e) stirring the waste water/nitrate mixture,
f) controlling the addition of additional nitrate and/or additional lye by measuring at least one parameter of the waste water/nitrate mixture,
g) stopping the stirring,
h) decanting, including the discharge of clarified water at a second filling level (Niv B), the filling level (Niv B) being at 50-70%, preferably at 60%.

2. Method according to claim 1,
characterized in that
the nitrate is added in the form of nitric acid or dissolved nitrate salt.

3. Method according to claim 1,
characterized in that
the waste water/nitrate mixture is stirred at intervals.

4. Method according to claim 1,
characterized in that
lye in the form of milk of lime is added.

5. Method according to claim 1,
characterized in that
the addition of additional nitrate and/or additional lye takes place on the basis of the measurement of the pH-value of the waste water/nitrate mixture.

6. Method according to claim 5,
characterized in that
additional nitrate is added to the waste water/nitrate mixture if the pH-value is >7.0.

7. Method according to claim 1,
characterized in that
the addition of additional nitrate and/or additional lye takes place on the basis of the
measurement of the nitrate concentration in the waste water/nitrate mixture.

8. Method according to claim 1,
characterized in that
the addition of additional nitrate and/or additional lye takes place on the basis of the measurement of the oxidation-reduction potential of the waste water/nitrate mixture.

9. Method according to claim 8,
characterized in that
in the event of a negative and decreasing oxidation-reduction potential of the waste water/nitrate mixture additional lye is added until a pH-value of 7.5 is reached.

10. Method according to claim 1,
characterized in that
the stirring is stopped if the pH-value no longer changes and the oxidation-reduction potential is >0 mV.

11. Method according to claim 10,
characterized in that
the pH-value is between 6.5 and 7.0.

12. Method according to claim 1,
characterized in that
the waste water/nitrate mixture is aerated with strip-air.

13. Device for carrying out a method according to claim 1,
characterized in that
the device comprises a container (1) with a settling cavity in the bottom of the container, as well as a stirrer (3), and furthermore a pH-value measuring device and a dosing device for the addition of nitrate (5).

14. Device according to claim 13,
characterized in that
the device comprises a nitrate concentration measuring device and/or an oxidation-reduction potential measuring device (4).

15. Device according to claim 13,
characterized in that
the device comprises an aeration device (7).
